(19) United States
(12) Patent Application Publication
(10) Pub. No.: US 2022/0277253 A1
(43) Pub. Date: Sep. 1, 2022

(54) INFORMATION PROCESSING DEVICE, INFORMATION PROCESSING METHOD, AND NON-TRANSITORY COMPUTER-READABLE MEDIUM

(71) Applicant: bellFace Inc., Tokyo (JP)

(72) Inventor: Kazuaki NAKAJIMA, Tokyo (JP)

(73) Assignee: bellFace Inc., Tokyo (JP)

(21) Appl. No.: 17/680,925

(22) Filed: Feb. 25, 2022

(30) Foreign Application Priority Data
Mar. 1, 2021 (JP) 2021-032163

(51) Int. Cl. G06Q 10/06; H04L 65/403

(52) U.S. Cl. CPC G06Q 10/06398; H04L 65/403

(57) ABSTRACT

An information processing device includes a control unit. The control unit obtains information regarding an interview organizer during an online interview between the interview organizer and an interviewee, and displays a suggestion for the interview organizer on a terminal device of the interview organizer on the basis of the information regarding the interview organizer.

### CROSS-REFERENCE TO RELATED APPLICATIONS

The present application claims priority on the basis of Japanese Patent Application No. 2021-032163 filed on Mar. 1, 2021, the entire contents of which are incorporated herein by reference.

### TECHNICAL FIELD

The present disclosure relates to an information processing device, an information processing method, and a non-transitory computer-readable medium.

### BACKGROUND ART

There is a Web conference system as an information system in which materials are shared in real time between remote places (Japanese Patent Laid-open No. 2014-26311).

### SUMMARY

In a case where a sales representative intends to hold an interview by using the Web conference system, when the sales representative is an experienced sales representative or the like, the sales representative can hold the interview without any problem. However, it may be difficult for an inexperienced sales representative such as a newcomer to hold an interview smoothly.

According to one aspect of the present disclosure, an information processing device is provided. This information processing device includes a control unit. The control unit obtains information regarding an interview organizer during an online interview between the interview organizer and an interviewee, and displays a suggestion for the interview organizer on a terminal device of the interview organizer on the basis of the information regarding the interview organizer.

### BRIEF DESCRIPTION OF THE DRAWINGS

FIG. 1 is a diagram illustrating an example of a system configuration of an information processing system;

FIG. 2 is a diagram illustrating an example of a hardware configuration of a server device;

FIG. 3 is a diagram illustrating an example of a hardware configuration of a client device;

FIG. 4 is a diagram illustrating an example of a functional configuration of the server device;

FIG. 5 is an activity diagram illustrating an example of information processing of the server device;

FIG. 6 is a diagram illustrating an example of reference information;

FIG. 7 is a diagram illustrating an example of a screen during an interview; and

FIG. 8 is a diagram illustrating a list of advice.

### DETAILED DESCRIPTION

An embodiment of the present invention will hereinafter be described with reference to the drawings. Various characteristic items described in the following embodiment can be combined with each other.

A program for implementing software appearing in the present embodiment may be provided as a non-transitory computer-readable medium, may be provided so as to be downloadable from an external server, or may be provided such that functions of the program are implemented on a client terminal by starting the program on an external computer (what is called cloud computing).

In addition, in the present embodiment, a “unit” can include, for example, a combination of hardware resources implemented by a circuit in a broad sense and information processing of software that can be concretely implemented by these hardware resources. In addition, the present embodiment handles various pieces of information. These pieces of information are, for example, represented by physical values of signal values indicating voltage and current, the levels of signal values as a bit aggregate of a binary number constituted by 0s or 1s, or quantum superposition (what is called qubits), and communication and calculation thereof can be performed on a circuit in a broad sense.

In addition, a circuit in a broad sense is a circuit implemented by at least appropriately combining a circuit, circuitry, a processor, a memory, and the like. That is, a circuit in a broad sense includes an application specific integrated circuit (ASIC), a programmable logic device (for example, a simple programmable logic device (SPLD), a complex programmable logic device (CPLD), and a field programmable gate array (FPGA)), and the like.

### First Embodiment

### 1. System Configuration

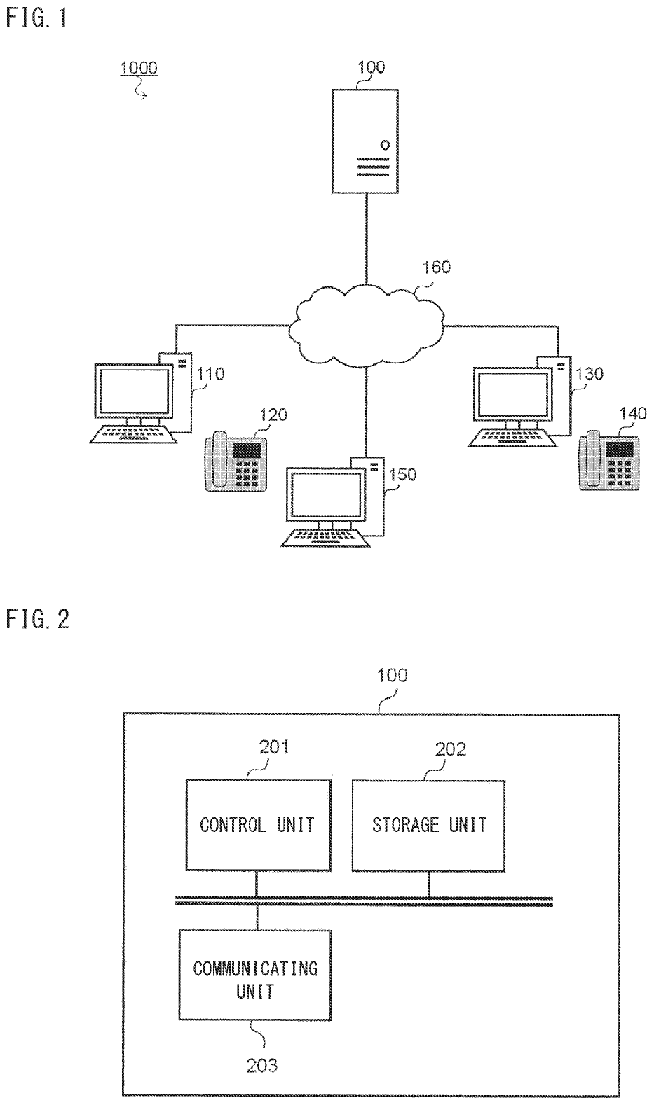

FIG. 1 is a diagram illustrating an example of a system configuration of an information processing system 1000. The information processing system 1000 includes, as a system configuration, a server device 100, a client device 110, a telephone 120, a client device 130, and a telephone 140. The server device 100, the client device 110, the client device 130, and a client device 150 are connected to each other so as to be capable of communication via a network 160. In addition, the telephone 120 and the telephone 140 are connected so as to enable voice communication via a telephone network not illustrated.

The client device 110 is a device used by an interview organizer who organizes an interview. The client device 130 is a device used by an interviewee. The client device 150 is a device used by a manager of the interview organizer. The client device 110, the client device 130, and the client device 150 may be a PC (Personal Computer), may be a smart phone, or may be a tablet type computer. However, in the present embodiment, description will be made by using a PC as an example of a client device for simplification of the description. Incidentally, interviews include an interview, a sales meeting, and the like. However, in the present embodiment, description will be made by using an interview as an example of an interview. The server device 100 is an example of an information processing device. In the information processing system 1000, voices of the interview or the like are mutually communicated by using the telephone 120 and the telephone 140. Hence, according to the information processing system 1000, even when an Internet line is congested, for example, voices are delivered stably and are not interrupted.

### 2. Hardware Configuration

### (1) Hardware Configuration of Server Device 100

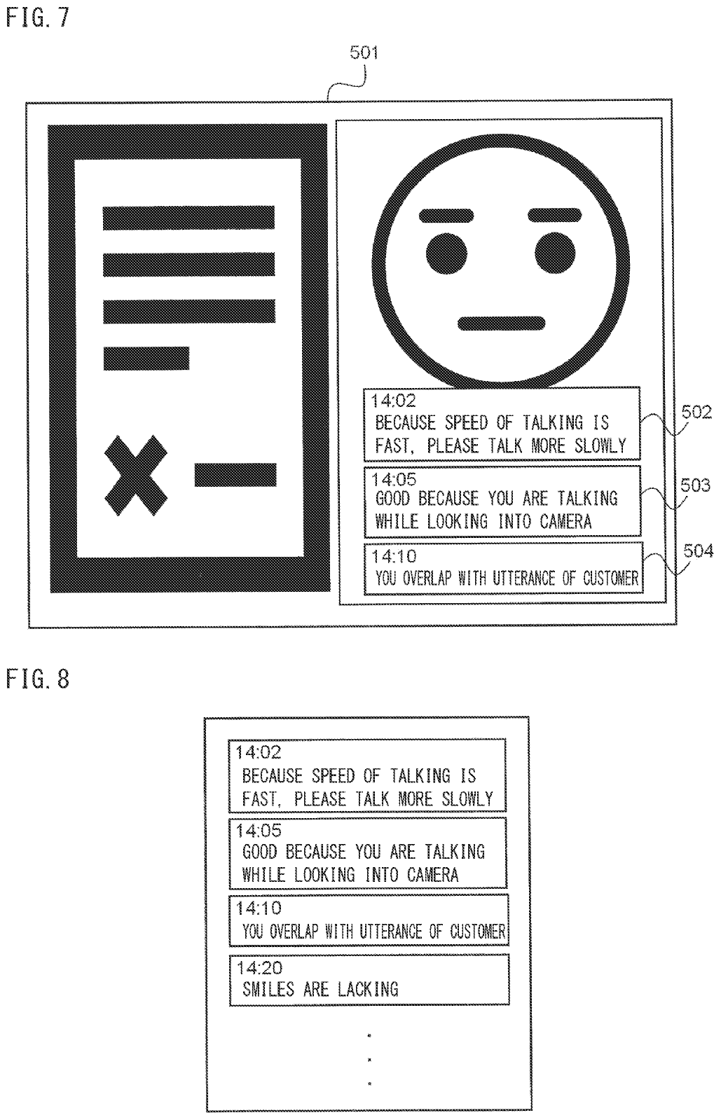

FIG. 2 is a diagram illustrating an example of a hardware configuration of the server device 100. The server device 100 includes, as a hardware configuration, a control unit 201, a storage unit 202, and a communicating unit 203. The control unit 201 is, for example, a central processing unit (CPU) or the like. The control unit 201 controls the whole of the server device 100. The storage unit 202 is, for example, a read only memory (ROM), a random access memory (RAM), a hard disk drive (HDD), a solid state drive (SSD), or any combination of these. The storage unit 202 stores a program, data used when the control unit 201 performs processing on the basis of the program, and the like. The control unit 201 performs the processing on the basis of the program stored in the storage unit 202, and thereby implements a functional configuration of the server device 100 illustrated in FIG. 4 to be described later and information processing of an activity diagram illustrated in FIG. 7 to be described later. The communicating unit 203 connects the server device 100 to the network 160, and controls communication with an external device.

### (2) Hardware Configuration of Client Device 110

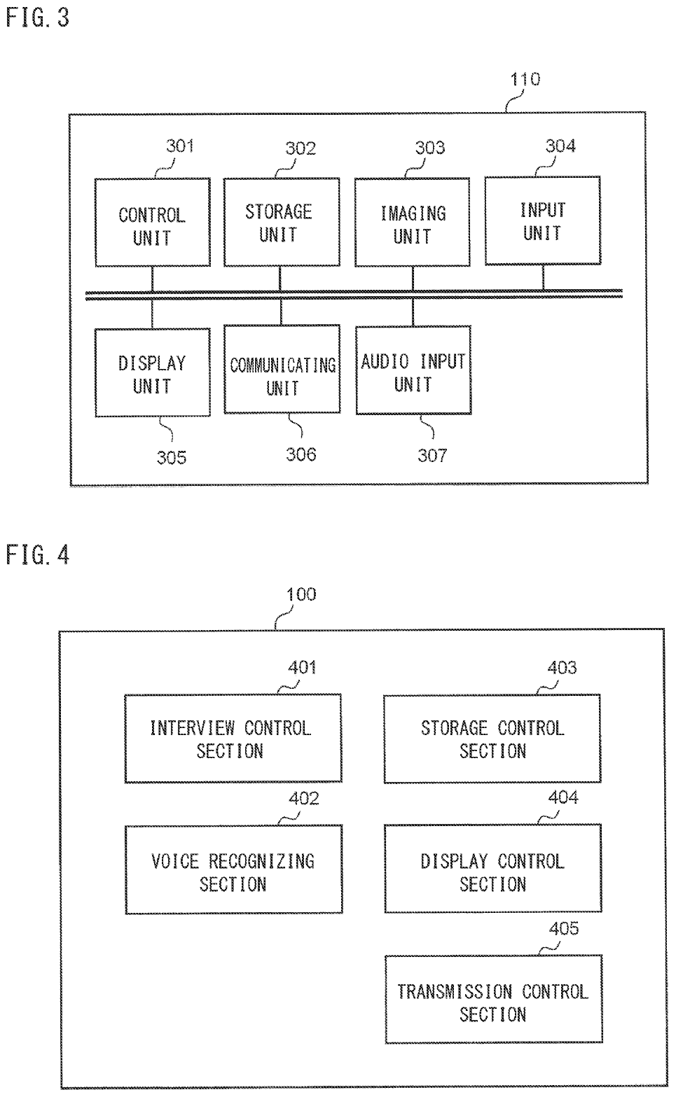

FIG. 3 is a diagram illustrating an example of a hardware configuration of the client device 110. The client device 110 includes, as a hardware configuration, a control unit 301, a storage unit 302, an imaging unit 303, an input unit 304, a display unit 305, a communicating unit 306, and an audio input unit 307. The control unit 301 is, for example, a CPU or the like. The control unit 301 controls the whole of the client device 110. The storage unit 302 is a ROM, a RAM, an HDD, an SSD, or any combination of these. The storage unit 302 stores a program, data used when the control unit 301 performs processing on the basis of the program, and the like. The control unit 301 performs the processing on the basis of the program stored in the storage unit 302, and thereby implements a functional configuration of the client device 110. The imaging unit 303 images a subject. The subject is, for example, an operator of the client device 110. The input unit 304 is, for example, a keyboard, a mouse, or the like. The input unit 304 transmits input information to the control unit 301 on the basis of an input operation or the like. The display unit 305 is, for example, a display or the like. The display unit 305 displays a result of the information processing by the control unit 301 or the like. The communicating unit 306 connects the client device 110 to the network 160, and controls communication with an external device. The audio input unit 307 is, for example, a microphone or the like. The voice of the operator is input to the audio input unit 307.

The client device 130 and the client device 150 also have a hardware configuration similar to the hardware configuration of the client device 110.

### 3. Functional Configuration

FIG. 4 is a diagram illustrating an example of a functional configuration of the server device 100. The server device 100 includes, as a functional configuration, an interview control section 401, a voice recognizing section 402, a storage control section 403, a display control section 404, and a transmission control section 405.

### Interview Control Section 401

The interview control section 401 performs control related to an interview on a device of the interview organizer, which is the client device 110 in the example of the present embodiment, and a device used by the interviewee, which is the client device 130 in the example of the present embodiment. For example, the interview control section 401 connects the client device 110 of the interview organizer and the client device 130 of a user of the interview to each other via the network 160, and controls the transferring of moving image data and voice data related to the interview and the like.

### Voice Recognizing Section 402

The voice recognizing section 402 performs voice recognition on the basis of the voice data of the interview, and convers the voice data into text. When there is a word that the voice recognizing section 402 does not know at a time of performing the voice recognition, the voice recognizing section 402 recognizes the word on the basis of data in a word conversion dictionary. In addition, the voice recognizing section 402 classifies speakers in the interview (the interview organizer organizing the interview or the interviewee undergoing the interview) on the basis of the waveforms of voices in the interview, and converts the waveforms of the voices into character strings (text) of the respective speakers. The voice recognizing section 402 may further analyze the converted character strings, and classify the speakers in the interview on the basis of a result of the analysis.

### Storage Control Section 403

The storage control section 403 associates moving image data of the interview and text data obtained by converting the voice data of the interview into text with each other, and stores resulting data as interview data in a storage area of the storage unit 202 or the like. Incidentally, in addition, information regarding a date and time of the interview, information regarding a sales representative, information regarding a customer, a list of advice displayed on the screen for the interview organizer, which has been given during the interview, as will be described later, and the like are added to the interview data, and are stored in the storage unit 202 or the like.

### Display Control Section 404

The display control section 404 performs control so as to display a screen related to the interview between the interview organizer and the interviewee. More specifically, the display control section 404 obtains information regarding the interview organizer during the online interview between the interview organizer and the interviewee, and displays advice for the interview organizer on the client device 110 of the interview organizer on the basis of the information regarding the interview organizer. More specifically, the display control section 404 displays advice for the interview organizer on the client device 110 of the interview organizer on the basis of the information regarding the interview organizer and reference information related to the interview. Here, the reference information related to the interview is information regarding the speed of talking, a line of sight, the number of smiles per unit time, and the like, which is set by the manager of the server device 100 or the like and serves as a model at a time of the interview of the interview organizer. Advice is set in association with each piece of reference information. The advice is, for example, a tip on a manner of talking in the interview, a tip on a manner of being imaged in the interview, or the like. Here, the advice is an example of a suggestion.

### Transmission Control Section 405

The transmission control section 405 transmits a list of advice displayed on the client device 110 of the interview organizer during the online interview to the client device 110 of the interview organizer on the basis of an end of the interview between the interview organizer and the interviewee.

### 4. Information Processing

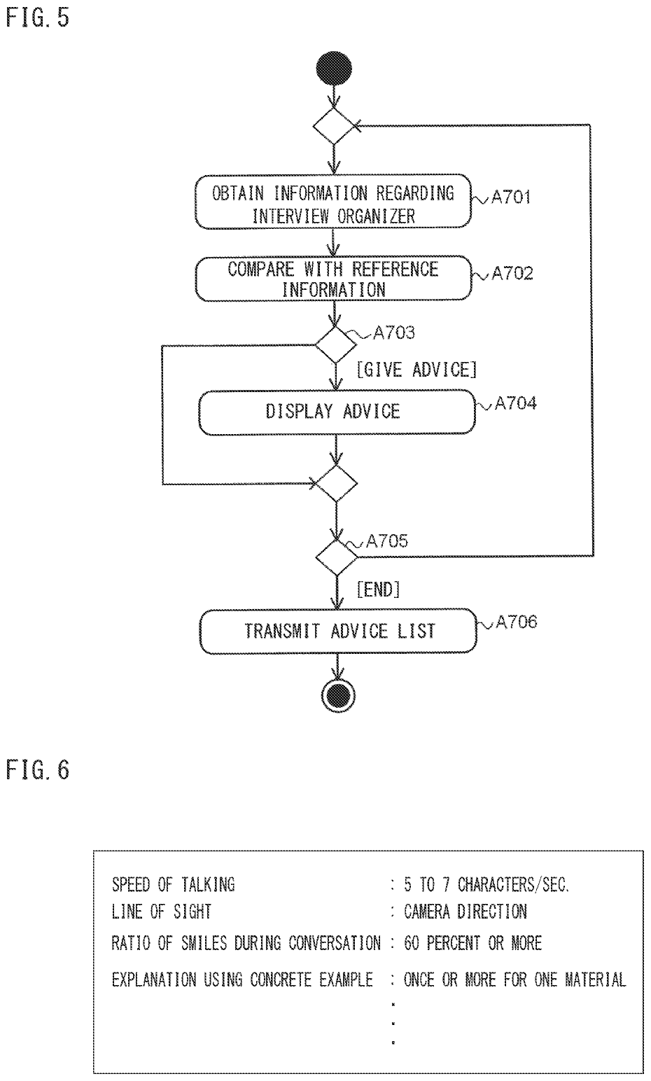

FIG. 5 is an activity diagram illustrating an example of information processing of the server device 100. The processing of FIG. 5 is started when the interview via the Internet between the interview organizer and the interviewee is started.

In A701, the display control section 404 obtains information regarding the interview organizer from the client device 110. Here, the information regarding the interview organizer is information regarding the voice of the interview organizer in the interview. The information regarding the voice is voice information of the voice uttered by the interview organizer, time information of the voice, and the like. Further, the display control section 404 may obtain, as the information regarding the interview organizer, the information regarding the voice of the interview organizer in the interview from the client device 110 and information regarding the voice of the interviewee in the interview from the client device 130. In addition, the display control section 404 may obtain information regarding an image of the interview organizer in the interview as information regarding the interview organizer. The information regarding the image is an image of the interview organizer imaged by the imaging unit 303 of the client device 110 or the like. In the present embodiment, description will be made supposing that the display control section 404 obtains, as the information regarding the interview organizer, the information regarding the voice of the interview organizer in the interview, the information regarding the voice of the interviewee in the interview, and the information regarding the image of the interview organizer.

In A702, the display control section 404 compares the information regarding the interview organizer, which information is obtained in A701, with the reference information. FIG. 6 is a diagram illustrating an example of the reference information. The reference information is stored in the storage unit 202 or the like.

In A703, the display control section 404 determines whether or not to display advice as a result of the comparison. When the display control section 404 determines that the advice is to be displayed, the display control section 404 advances the processing to A704. When the display control section 404 determines that the advice is not to be displayed, the display control section 404 advances the processing to A705. For example, the display control section 404 determines that the advice is to be displayed in a case where the speed of talking of the interview organizer in the information regarding the interview organizer, which is obtained in A701, does not correspond to the speed of talking of the reference information illustrated in FIG. 6.

In A704, the display control section 404 displays relevant advice on a screen in the interview, which is displayed on the display unit 305 of the client device 110. FIG. 7 is a diagram illustrating an example of a screen 501 during the interview. In the example of FIG. 7, pieces of advice 502 to 504 are displayed on the screen 501. The pieces of advice are displayed in time series in the order indicated by 502 to 504. When the number of pieces of advice displayed on the screen 501 becomes a predetermined number or more, the display control section 404 deletes oldest advice so that the screen 501 is not filled with advice. In the example of FIG. 7, the speed of talking of the interview organizer is faster than the speed of talking of the reference information illustrated in FIG. 6. Thus, the advice 502 is displayed at 14:02. In addition, the line of sight of the interview organizer is the same line of sight looking into a camera as the line of sight of the reference information illustrated in FIG. 6. Thus, the advice 503 is displayed at 14:05. In addition, because talks of the interview organizer and the interviewee overlap each other, the advice 504 is displayed at 14:10.

In A705, the display control section 404 determines whether or not the interview between the interview organizer and the interviewee is ended. When the display control section 404 determines that the interview is ended, the display control section 404 advances the processing to A706. When the display control section 404 determines that the interview is not ended, the display control section 404 advances the processing to A701.

In A706, the transmission control section 405 transmits a list of the advice displayed on the client device 110 of the interview organizer during the online interview to the client device 110 of the interview organizer on the basis of the end of the interview between the interview organizer and the interviewee. FIG. 8 is a diagram illustrating the list of the advice. As illustrated in FIG. 8, when the list of the advice is transmitted to the interview organizer after the end of the interview, the interview organizer can be given a chance to reflect. In particular, during a business negotiation, the interview organizer may be unable to notice the advice, or it is difficult for the interview organizer to reflect. Accordingly, when the transmission control section 405 transmits the list of the advice afterward, the advice that the interview organizer was not able to notice can be notified to the interview organizer, and the interview organizer can be given an opportunity to reflect.

As described above, according to the present embodiment, the server device 100 makes the display of advice on improvement points or the like unable to be noticed unless attending the interview, such as a manner of talking and a manner of being imaged. It is thereby possible to improve online interview techniques efficiently.

### First Modification

A modification of the first embodiment will be described. In a first modification, the reference information of FIG. 6 is set for each type of business of a company of the interviewee. In A702, the display control section 404 in the first modification compares the information regarding the interview organizer, which is obtained in A701, with the reference information of the type of business of the interviewee. The display control section 404 may obtain the type of business of the interviewee on the basis of setting by the interview organizer or the like, or may obtain the type of business of the interviewee from business card information of the interviewee in a case where the business card information of the interviewee can be obtained.

According to the first modification, the server device 100 can make a comparison with a model case corresponding to a type of business during an online interview, and, for example, display appropriate advice corresponding to the type of business on a screen.

### Second Modification

A modification of the first embodiment will be described. In a second modification, the control unit 201 of the server device 100 sets the reference information related to the interview on the basis of history information related to the interview of a designated interview organizer who has a good interview result (sales result in a case where the interview is for sales) (for example, the history information is the interview data of the interview organizer). For example, the control unit 201 analyzes the interview data of the interview organizer who has a good interview result, obtains, as a result of the analysis, information regarding the speed of talking, a line of sight, a ratio of smiles during conversation, the number of times of explanation using a concrete example during the interview, and the like, and sets the reference information related to the interview on the basis of the obtained information. The display control section 404 in the second modification compares the information regarding the interview organization and the reference information with each other. When the display control section 404 then determines that advice is to be given as a result of the comparison, the display control section 404 displays relevant advice on the screen during the interview, which is displayed on the display unit 305 of the client device 110.

According to the second modification, the server device 100 can, for example, display, on a screen, advice corresponding to the speed of talking, a line of sight, a ratio of smiles, the number of times of explanation using a concrete example during the interview, and the like of the interview organizer having a good sales result.

### Third Modification

A modification of the first embodiment will be described. In a third modification, the control unit 201 of the server device 100 sets the reference information related to the interview for each attribute of the interview organizer on the basis of history information related to the interview of a designated interview organizer who has a good interview result (sales result in a case where the interview is for sales) (the history information is, for example, the interview data of the interview organizer). For example, the control unit 201 analyzes the interview data of the interview organizer who has a good interview result, and obtains attributes of the interview organizer. Here, the attributes of the interview organizer are gender, age, and the like. In addition, the control unit 201 analyzes the interview data of the interview organizer who has a good interview result, obtains, as a result of the analysis, information regarding the speed of talking, a line of sight, a ratio of smiles during conversation, the number of times of explanation using a concrete example during the interview, and the like, and sets the reference information related to the interview for each attribute of the interview organizer on the basis of the obtained information and the attributes of the interview organizer. The display control section 404 in the second modification obtains attribute information of the interview organizer on the basis of a captured image captured by the imaging unit 303 or the like. Then, the display control section 404 compares the information regarding the interview organizer and the reference information corresponding to the attribute information with each other. When the display control section 404 then determines that advice is to be given as a result of the comparison, the display control section 404 displays relevant advice on the screen during the interview, which is displayed on the display unit 305 of the client device 110.

According to the third modification, the server device 100 can, for example, display, on a screen, advice corresponding to the speed of talking, a line of sight, a ratio of smiles, the number of times of explanation using a concrete example during the interview, and the like of the interview organizer having a good sales result for each attribute of the interview organizer.

### Fourth Modification

A modification of the first embodiment will be described. In a fourth modification, after the end of the interview between the interview organizer and the interviewee, the transmission control section 405 transmits the list of the advice displayed on the client device 110 of the interview organizer during the online interview to the client device 110 of the interview organizer and the client device of the manager of the interview organizer. Information regarding the client device of the manager of the interview organizer is set for each interview organizer. In the example of FIG. 1, the client device of the manager of the interview organizer is the client device 150.

According to the fourth modification, it is possible to transmit the list of the advice to the interview organizer and the manager of the interview organizer. Hence, the manager, also, can grasp improvement points or the like at the time of the interview of the interview organizer, and can give advice on the improvement points or the like.

### Appendix

Provision may be made in each of modes described in the following.

In the information processing device, the control unit displays a suggestion for the interview organizer on the terminal device of the interview organizer on the basis of the information regarding the interview organizer and reference information related to the interview.

In the information processing device, the reference information related to the interview is information set on the basis of history information related to the interview of an interview organizer selected according to an interview result.

In the information processing device, the information regarding the interview organizer is information regarding a voice of the interview organizer in the interview.

In the information processing device, the information regarding the interview organizer is information regarding voices of the interview organizer and the interviewee in the interview.

In the information processing device, the information regarding the interview organizer is information regarding an image of the interview organizer in the interview.

In the information processing device, the control unit transmits a list of suggestions displayed on the terminal device of the interview organizer during the online interview to the terminal device of the interview organizer on the basis of an end of the interview between the interview organizer and the interviewee.

In the information processing device, the control unit transmits the list of the suggestions displayed on the terminal device of the interview organizer during the online interview to the terminal device of the interview organizer and a terminal device of a manager of the interview organizer on the basis of the end of the interview between the interview organizer and the interviewee.

In the information processing device, the suggestion is a tip on a manner of talking in the interview.

In the information processing device, the suggestion is a tip on a manner of being imaged in the interview.

An information processing method performed by an information processing device, the information processing method including:

obtaining information regarding an interview organizer during an online interview between the interview organizer and an interviewee, and displaying a suggestion for the interview organizer on a terminal device of the interview organizer on a basis of the information regarding the interview organizer.

A program for making a computer function as the control unit of the information processing device.

Needless to say, these are not the only modes.

For example, a non-transitory computer-readable medium, on which the above-described program is stored (recorded), may be provided.

In addition, the foregoing embodiment and the foregoing modifications may be optionally combined with each other and carried out.

In addition, in the foregoing embodiment and the like, an example has been illustrated in which the server device 100 generates a screen, and transmits the screen to the client device 110 and the like. However, the server device 100 may transmit data for generating the screen to the client device 110 or the like, and the client device 110 or the like that receives the data may generate the screen on the basis of the data.

In addition, the foregoing embodiment and each of the foregoing modifications may be optionally combined with each other and carried out.

Finally, while various embodiments according to the present invention have been described, these embodiments are presented as an example, and are not intended to limit the scope of the invention. The novel embodiments can be carried out in various other forms, and various omissions, replacements, and changes can be made without departing from the spirit of the invention. The embodiments and modifications thereof are included in the scope and spirit of the invention, and are included in the scope of the invention described in claims and equivalents thereof.

What is claimed is:

1. An information processing device comprising:
a control unit,
the control unit obtaining information regarding an interview organizer during an online interview between the interview organizer and an interviewee, and displaying a suggestion for the interview organizer on a terminal device of the interview organizer on a basis of the information regarding the interview organizer.

2. The information processing device according to claim 1, wherein
the control unit displays the suggestion for the interview organizer on the terminal device of the interview organizer on a basis of the information regarding the interview organizer and reference information related to the interview.

3. The information processing device according to claim 2, wherein
the reference information related to the interview is information set on a basis of history information related to an interview of an interview organizer selected according to an interview result.

4. The information processing device according to claim 1, wherein
the information regarding the interview organizer is information regarding a voice of the interview organizer in the interview.

5. The information processing device according to claim 1, wherein
the information regarding the interview organizer is information regarding voices of the interview organizer and the interviewee in the interview.

6. The information processing device according to claim 1, wherein
the information regarding the interview organizer is information regarding an image of the interview organizer in the interview.

7. The information processing device according to claim 1, wherein
the control unit transmits a list of suggestions displayed on the terminal device of the interview organizer during the online interview to the terminal device of the interview organizer on a basis of an end of the interview between the interview organizer and the interviewee.

8. The information processing device according to claim 7, wherein
the control unit transmits the list of the suggestions displayed on the terminal device of the interview organizer during the online interview to the terminal device of the interview organizer and a terminal device of a manager of the interview organizer on the basis of the end of the interview between the interview organizer and the interviewee.

9. The information processing device according to claim 1, wherein
the suggestion is a tip on a manner of talking in the interview.

10. The information processing device according to claim 1, wherein
the suggestion is a tip on a manner of being imaged in the interview.

11. An information processing method performed by an information processing device, the information processing method comprising:
obtaining information regarding an interview organizer during an online interview between the interview organizer and an interviewee, and displaying a suggestion for the interview organizer on a terminal device of the interview organizer on a basis of the information regarding the interview organizer.

12. A non-transitory computer-readable medium, wherein
a program for making a computer function as the control unit of the information processing device according to claim 1 is recorded.
